(19) United States
(12) Patent Application Publication
(10) Pub. No.: US 2008/0126865 A1
(43) Pub. Date: May 29, 2008

(54) DEBUGGING SYSTEM AND METHOD

(75) Inventor: Sung-Bum Lee, Gyeonggi-Do (KR)

Correspondence Address: LEE, HONG, DEGERMAN, KANG & SCHMADEKA, 660 S. FIGUEROA STREET, Suite 2300, LOS ANGELES, CA, 90017, US

(73) Assignee: LG ELECTRONICS INC.

(21) Appl. No.: 11/768,012

(22) Filed: Jun. 25, 2007

(30) Foreign Application Priority Data
Jun. 27, 2006 (KR) 10-2006-0058333

(51) Int. Cl. G06F 11/00

(52) U.S. Cl. 714/34; 714/E11.002

(57) ABSTRACT

A debugging system, device and method for debugging the error malfunctions of a target device is provided. The system includes a debugging device setting a permanent break point in a target device when the debugging device is connected with the target device, and the target device stopping operation when the connection between the target device and the debugging device is released and the break point is executed. The system effectively sustains the break point in the target device, even after the target device is disconnected from the debugging device.

### CROSS REFERENCE TO RELATED APPLICATION

Pursuant to 35 U.S.C. § 119(a), this application claims the benefit of earlier filing date and right of priority to Korean Application No. 10-2006-0058333 filed on Jun. 27, 2006, the contents of which are hereby incorporated by reference herein in their entirety.

### FIELD OF THE INVENTION

The present invention is directed to a debugging technique and, more specifically, to a debugging system, device and method for performing debugging by reproducing a malfunction error of a target device.

### DISCUSSION OF THE RELATED ART

When developing software, big and small errors may occur in the development process. For example, several errors may be generated in designing and coding a particular program. Software developers refer to the errors in the program as “bugs”; and the detection of a hidden bug and establishing the cause of the bug is known as “debugging.” Debugging is a requisite for reducing the defect of a product and improving the quality of software, including a software platform (WISE), a mobile platform (CDMA/GSM/3G), an operating system (OS), and a hardware platform (ARM), etc.

The larger the developed software is in size, the harder its bugs are to detect, and if the bug is positioned deep in the software, reliability of a product is threatened. Therefore, before the product is placed on the market, developers perform many tests on the product to detect errors. The purpose of product testing is to discover an error or malfunction, but developers also realize that reproducing a discovered error or malfunction is also important.

Errors appearing in particular environments may be caused by a structural problem of a system or various other environmental factors. Thus, although the testing is performed under the same conditions, an error may intermittently appear at one time making it difficult to reproduce the error through testing generally performed in a laboratory.

FIG. 1 illustrates a general debugging system of the related art. As illustrated in FIG. 1, the debugging system includes a target device 200 and a debugging device 100 physically connected with the target device 200 and detecting an error of a source level.

The target device 200 of FIG. 1 is presumed to be a mobile terminal that malfunctions when it enters a particular area. In the laboratory, a developer may repeatedly perform various types of tests on the mobile terminal to reproduce the mobile terminal malfunction.

Often during product testing, the developer must travel to the corresponding area where the mobile terminal malfunctioned carrying various testing equipments. When testing on location, the developer connects the debugging device 100 and the mobile terminal 200 and repeatedly performs tests on the mobile terminal. While the testing is performed, the developer continuously monitors the testing procedure.

FIG. 2 is a flow chart illustrating the processes of a debugging method, according to the related art. The operation of the related art debugging system will be described with reference to FIG. 2.

For debugging the target device 200, a user connects the target device 200 to the debugging device 100 (step S10). As the debugging device 100 senses its connection with the target device 200, it instructs the target device 200 to set a break point at a particular program designated by the user. According to the instruction of the debugging device 100, the target device 200 replaces an arbitrary code of the designated program with a break point code (step S20).

The break point is a program command for allowing the target device 200 to stop at a particular execution region to observe an error generated in the target device 200. When the break point is set, the user assigns a certain condition value (condition_X) to the break point so that the break point can be operated in a particular situation, namely, in a situation that an error has been previously generated.

Thereafter, when the break point is set in the target device 200 (step S20), that is, when the replacement of the arbitrary code with the break point is completed, the user or the developer performs various tests to reproduce the malfunction of the target device 200 (step S30).

When the condition (condition_X) is satisfied in a situation (step S40), the break point is operated. Then, the target device 200 stops operating (step S50) and deletes the break point. Herein, the debugging device 100 starts debugging to detect a source level error of the target device 200 (step S60).

As stated above, in the related art debugging system, testing of the product, i.e., mobile terminal, should be performed in a state that the debugging device 100 and the target device 200 are connected. While the testing is performed, the developer should continue monitoring the test procedure. When the debugging device is disconnected from the target device 200, the break point set in the target device 200 is deleted, resulting in the user not being able to continue testing of the product.

A problem of the related art debugging method is that in order to eliminate a bug appearing in a particular environment, a similar communication environment is artificially established in the laboratory, or, in the alternative, the user physically moves various equipment to the area providing the particular environment to perform testing on the product. In addition, while the test is performed, the developer should maintain system connection and continue monitoring the testing procedures on location.

### SUMMARY OF THE INVENTION

An object of the present invention is to provide a debugging system, device and method capable of maintaining a break point even when a target device is disconnected with a debugging unit.

One aspect of the present invention provides a debugging system for debugging error malfunctions of a target device, the system includes a debugging device setting a permanent break point in the target device when the debugging device is connected with the target device, and the target device stopping operation when the connection between the target device and the debugging device is released and the break point is executed, wherein the debugging device starts debugging the target device from a time point at which the target device operation was stopped.

It is contemplated that setting the break point comprises replacing an arbitrary code of a particular program designated by a user with a break point code. It is further contemplated that when operation of the target device is stopped, and a physical connection is re-established between the debugging device and the target device, the debugging device deletes the break point code and restores the arbitrary code in its place. Furthermore, it is contemplated that the break point is executed when a certain condition is met.

It is contemplated that the target device is a mobile terminal. It is further contemplated that the target device is an embedded system.

In another aspect of the present invention, a debugging device for debugging error malfunctions in a target device is provided, the device including a break point setting unit setting a permanent break point in the target device while connected with the target device, and an error control unit performing debugging on the target device when operation of the target device is stopped by the break point after the connection with the target device is released, wherein debugging is started from a state at which the target device operation was stopped.

It is contemplated that the break point setting unit replaces an original code with a break point code. It is further contemplated that when the connection with the stopped target device is re-established, the break point setting unit deletes the break point code and restores the original code in its place.

It is contemplated that the target device is a mobile terminal. It is further contemplated that the target device is an embedded system.

In another aspect of the present invention, a target device adapted to debugged by a debugging device is provided, the target device including a memory unit storing a program setting and controlling a permanent break point, and a controller stopping operation of the target device when the break point is executed, and controlling a debugging operation to start debugging from a stopped operation region of the target device, wherein the permanent break point is sustained even after the target device is disconnected from the debugging device.

It is contemplated that when the target device operation of the target device is stopped, the controller establishes a connection to the debugging device to allow the debugging device to perform debugging.

It is contemplated that the break point setting unit replaces an original code with a break point code. It is further contemplated that before debugging is performed, the controller deletes the break point code and restores the original code in its place.

In another aspect of the present invention, a method for detecting an error by a debugging system including a debugging device and a target device is provided, the method including, connecting the debugging device to the target device and setting a permanent break point in the target device, releasing the connection and testing the target device, stopping an operation of the target device when the break point is executed, and connecting the debugging device to the target device, and debugging the target device starting from the position at which the operation was stopped.

It is contemplated that the method further includes deleting a break point code from the target device and restoring the original code in its place before debugging is performed. It is further contemplated that setting the permanent break point comprises replacing an arbitrary code of a particular program designated by a user with a break point code.

It is contemplated that the target device is a mobile terminal. It is further contemplated that the target device is an embedded system.

Additional advantages, objects, and features of the invention will be set forth in part in the description, which follows, and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 illustrates a configuration of a debugging system according to the related art.

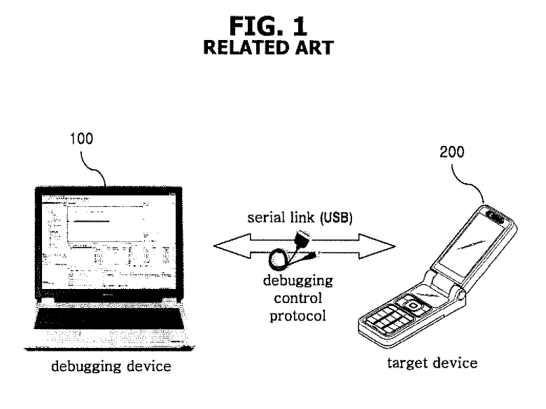

FIG. 2 is a flow chart illustrating the processes of a debugging method, according to the related art.

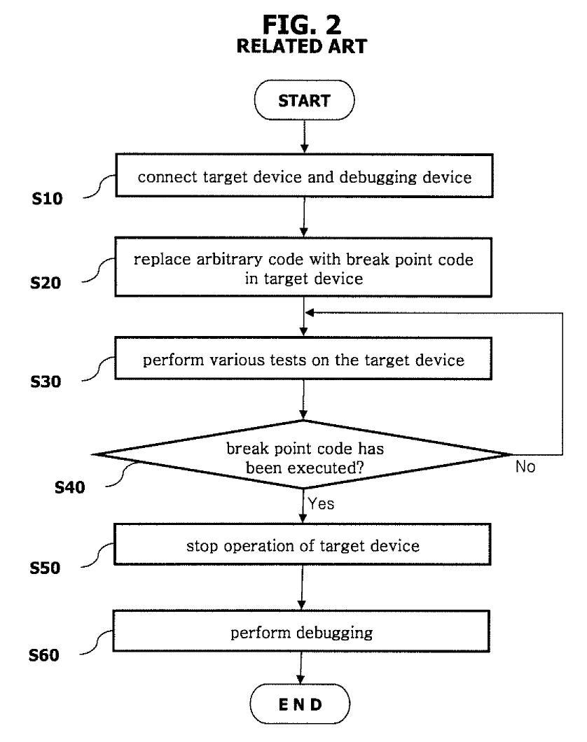

FIG. 3 is a schematic block diagram of a debugging system according to an embodiment of the present invention.

FIG. 4 is a flow chart illustrating a debugging method according to an embodiment of the present invention.

FIG. 5 illustrates a source code and a mechanical language code of a program in which a break point code has been set according to an embodiment of the present invention.

FIG. 6 is a flow chart illustrating some processes in the debugging method of FIG. 4 at a source level.

FIG. 7 is a schematic block diagram illustrating the target device according to the embodiment of the present invention.

### DETAILED DESCRIPTION OF THE INVENTION

The present invention has been devised to effectively sustain a debugging break point, even after a connection of a target device to a debugging device is released, and to overcome the problem of limited mobility of a debugging device.

In the present invention, a user or developer can carry the target device and easily reproduce a malfunction of the target device on the spot. The embodiment of the present invention will now be described with reference to the accompanying figures.

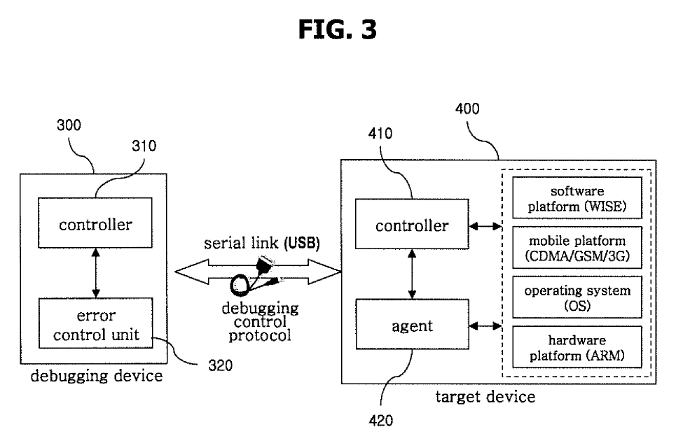

FIG. 3 is a schematic block diagram of a debugging system according to an embodiment of the present invention. A debugging system of the present invention includes a debugging device 300 and a target device 400.

The debugging device 300 includes a controller 310, also referred to as a break point setting unit 310, for setting a certain break point of the target device 400 physically connected to the debugging device, and releasing the connection. An error control unit 320, also known as a debugging tool 320, is provided for performing debugging starting from an execution region of the target device 400 when a connection to the target device is established. The execution region is a point at which the target device has stopped according to the user's instruction under control of the break point.

The target device 400 includes a controller 410 for replacing a particular code of a program, determined by the user, with a break point code when the target device receives a break point setting command from the debugging device 300. The target device also includes an agent 420 for sustaining the break point even after the connection to the debugging device is released, and stopping the operation of the target device when the break point code is executed.

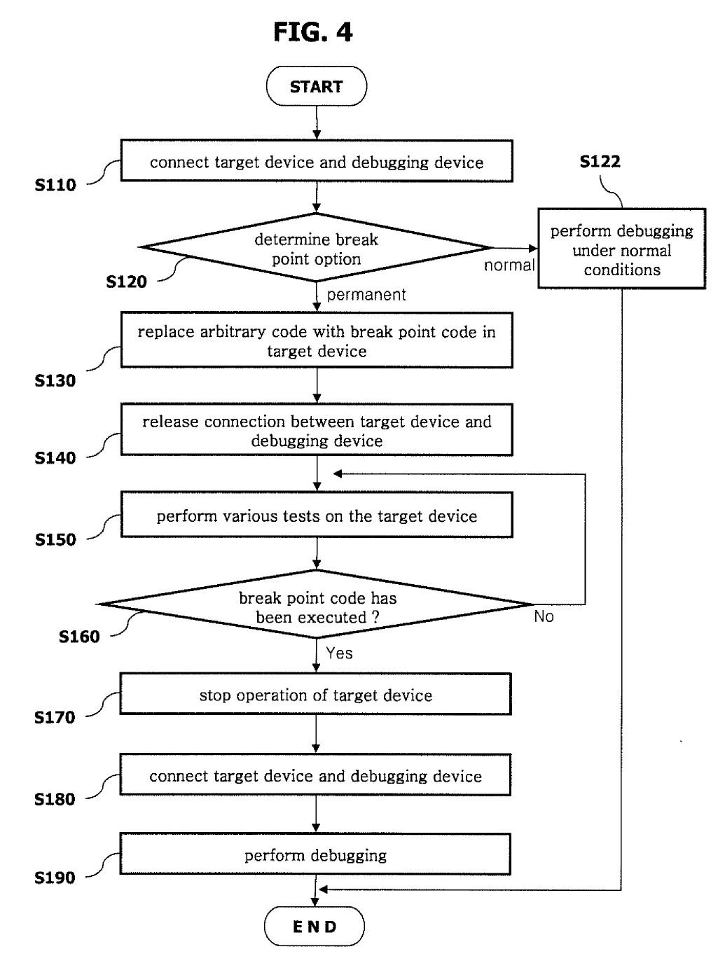

The operation of the debugging system according to the present invention will now be described with reference to FIG. 4. FIG. 4 is a flow chart illustrating a debugging method according to an embodiment of the present invention.

To debug the target device 400, the user connects the target device 400 to the debugging device 300 (step S110). The controller 310 of the debugging device 300 detects the connection with the target device 400 and determines an option setting, i.e., permanent or normal, of the break point according to a user instruction (step S120).

When a general debugging operation is carried out in a laboratory, the option of the break point is set as normal. The debugging device 300 performs debugging with the authority for controlling the target device 400, i.e., a control right. Specifically, the debugging device 300 uses its control right authority to control the target device to perform normal debugging (step S122).

For example, in the related art debugging system, when the break point option is set as normal, the break point is effectively operated while the debugging device 300 has the authority to controll the target device 400, specifically, while the debugging device and the target device are connected (step S122). When the two devices 300 and 400 are disconnected, the break point is not operated. Actually, when the two devices 300 and 400 are disconnected, the break point code is deleted from the target device.

When the option setting of the break point is determined to be permanent (step S120), the controller 310 instructs the agent 420 of the target device 400 to set the break point at a particular program region designated by the user. Then, the agent 420 of the target device 400 replaces an arbitrary code of the designated program with a break point code (step S130).

As stated above, the break point is a program command to make the target device 400 stop its operation at a particular execution region to observe an error generated in the target device 400. The break point code, e.g., ‘DEAD’, non-mechanical language replaces arbitrary code at the particular region designated by the user in a mechanical language of a program suspected to have an error. When the arbitrary code is replaced by the break point code, the user assigns a certain condition value (condition_X) to the break point so that the break point can be operated in a particular situation, namely, in a state that an error has been previously generated.

Thereafter, when replacement of the arbitrary code by of the break point code is completed and when the break point is set in the target device 400 (step S130), the user disconnects the debugging device 300 from the target device 400 (step S140).

As mentioned above, if the option setting of the break point had been set as normal, the agent 420 deletes the break point code from the program when the debugging device 300 is disconnected from the target device 400 and restores the original code in its place. However, when the option setting of the break point is set as permanent, although the connection to the debugging device 300 is released, the agent 420 does not delete the break point code, but retains the code setting and sustains its function.

Accordingly, the user can move to another location and continue performing tests on the target device 400, even after the target device and the debugging device 300 are disconnected. Also, the user can perform testing on the target device 400 in a moving vehicle, or move to an area where a communication environment is not good and perform testing on the target device 400.

For example, it is assumed that the target device 400 has malfunctioned for an unknown reason in a particular area. In this case, in order to determine the cause of the malfunction, an error situation of the target device 400 should be reproduced. Thus, in order to reproduce the malfunction of the target device, the user transplants the break point into the target device, moves to the corresponding area, and performs various tests on the target device (step S150).

In the process of testing the target device 400 (step S150), when the break point code has been executed, i.e., condition (condition_X) is met (step 160), the break point is operated to stop the operation of the target device 400 (step S170) and the target device waits for a connection to the debugging device 300.

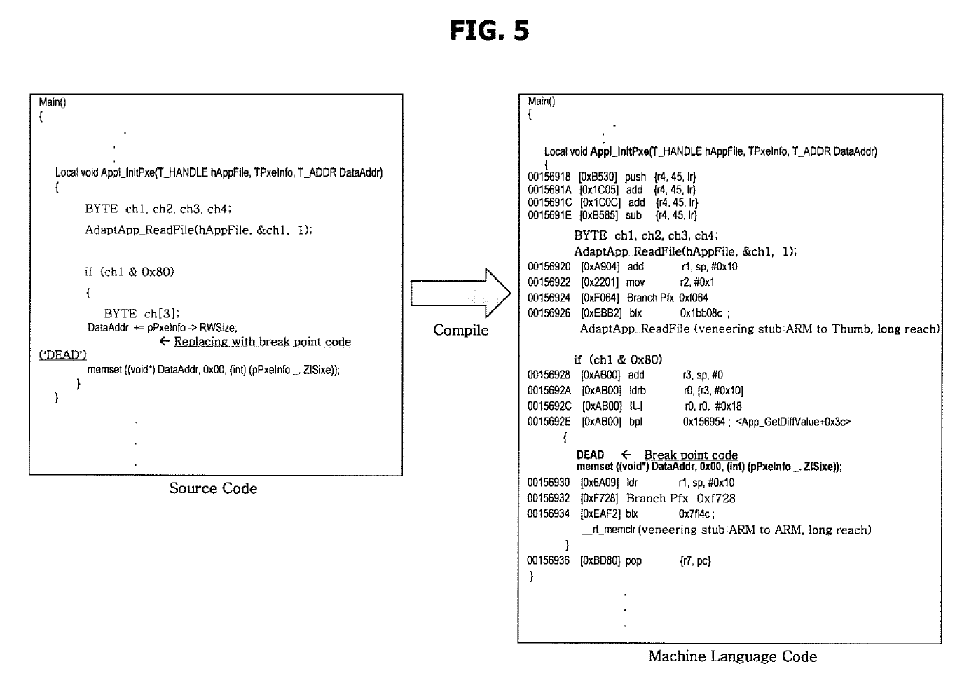

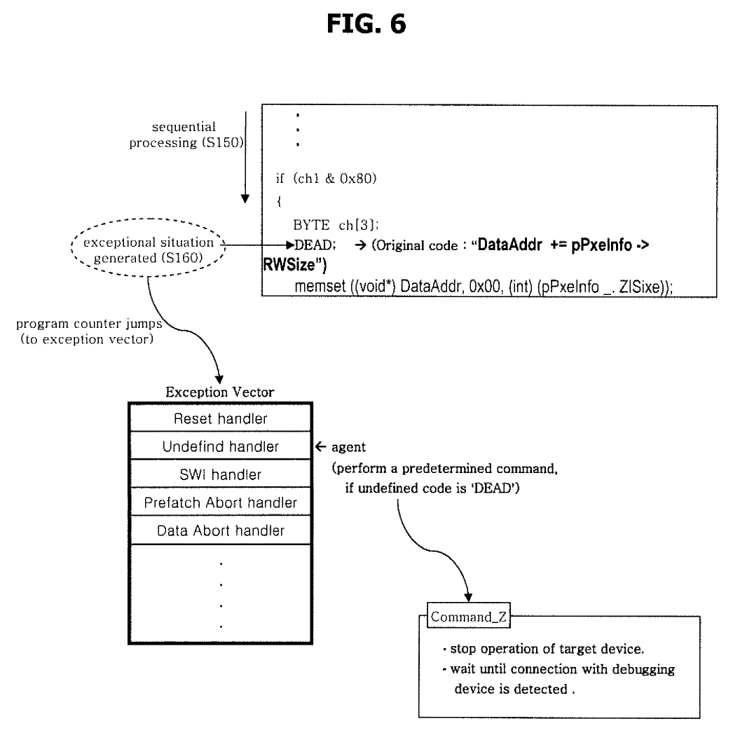

The method (steps S150˜S170) illustrated in FIG. 4 will be described in terms of software with reference to FIGS. 5 and 6. FIG. 5 illustrates a source code and a mechanical language code of a program in which a break point code has been set, and FIG. 6 is a flow chart illustrating the processes (steps S150-S170) in FIG. 4 at a source level.

When the user executes various functions of the target device 400 to test the target device 400, the controller 410 of the target device in turn executes the mechanical language codes of the corresponding programs. When the condition_X is satisfied in a situation, the non-mechanical break point code, e.g., ‘DEAD’ code, is executed and the target device controller recognizes the break point code ‘DEAD’ as an undefined command language.

When the controller 410 recognizes the particular code as the undefined command language, it jumps a program counter to an undefined handler of an exception vector. Then, the agent 420 that has been monitoring the undefined handler ascertains that the particular code ‘DEAD’ is the break point code and stops the operation of the target device 400. The agent 420 then waits for a connection, or reconnection, with the debugging device 300.

When the connection of the target device 400 and the debugging device 300 is established (step S180), the agent 420 detects this connection, deletes the break point code ‘DEAD’ from the target device 400, and restores the original code in its place so that the code can be re-executed beginning from this point in time.

Upon obtaining the authority to control the target device 400, a debugging tool 320 of the debugging device 300 starts debugging from the execution region of the target device 400 at which the operation of the target device 400 was stopped (step S190). The process of restoring the break point code ‘DEAD’ to the original code can be performed any time after the break point is operated (step S160) or after the debugging operation is performed (step S190).

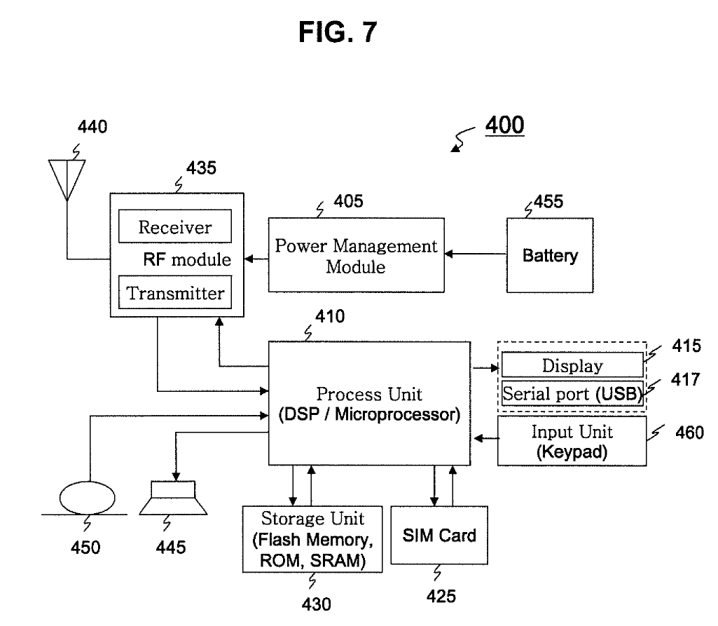

FIG. 7 is a schematic block diagram illustrating the target device 400, e.g., a mobile terminal, according to an embodiment of the present invention.

The mobile terminal 400, according to the present invention, includes a process unit 410, e.g., a microprocessor or a digital signal processor, an RF module 435, a power management module 405, an antenna 440, a battery 455, a display 415, a serial port 417 or a USB (Universal Serial Bus port), an input unit 460, e.g., a keypad, a storage unit 430, e.g., a flash memory, a ROM, an SRAM, etc., a SIM (Subscriber Identity Module) card 425 (optional), a speaker 445, and a microphone 450.

The user can input instruction information or various function execution commands, such as a phone number, by pressing a button of the keypad 460 or by using a voice driving unit, such as the microphone 450. When the instruction information, such as a phone number, is received, the process unit 410 performs an appropriate function, such as establishing a call to a corresponding reception side. In addition, the process unit searches operation data stored in the SIM card 425 or in the storage unit 430 and performs the function. Also, the process unit 410 displays the instruction and operation data information on the display 415 for the user's reference or convenience.

The process unit 410 generates a radio signal, including voice communication data to be transmitted to the RF module 435, or a subscriber message including instruction information, e.g., setting of an operation of the break point, designating a program for setting the break point, etc., inputted by the user, and then, transmits the radio signal or the subscriber message to a destination through the RF module 435 or to the debugging device 300 through the serial port 417 or the USB port. The serial port 417 transmits or receives various control signals during debugging to or from the debugging device 300.

The RF module 435 includes a receiver and a transmitter for transmitting and receiving radio signals. The antenna 440 facilitates transmission and reception of the radio signals. When a radio signal is received from a base station, the RF module 435 converts the signals into baseband frequencies to be processed by the process unit 410. The processed signals can be transformed into readable information or audible information outputted through the speaker 445, for example, when the radio signals are from a destination phone.

The process unit 410 is adapted for transmitting state information of the terminal to a destination or storing message history data of messages transferred from the user or server in the storage unit 430. The process unit 410 is further adapted for receiving a conditional request with respect to the message history data inputted by the user. Also, the process unit is adapted for processing the conditional request to read the message history data corresponding to the conditional request from the storage unit 430 and for outputting the message history data to the display 415.

The storage unit 430 stores a software control means, such as the program code or the agent 420. The process unit 410 is adapted for executing the soft control means or a control program stored in the storage unit.

As described above, the debugging system, device and method, according to the present invention, have the following advantages. By effectively sustaining the break point in the target device, even after the target device is disconnected from the debugging device, the inability to perform debugging unless the two devices are connected can be solved.

In addition, because the error revival testing can be performed with only the target device, the developer can move to more locations with the target device and perform testing to cope with various situations.

The foregoing embodiments and advantages are merely exemplary and are not to be construed as limiting the present invention. The present teaching can be readily applied to other types of apparatuses. The description of the present invention is intended to be illustrative and not to limit the scope of the claims. Many alternatives, modifications, and variations will be apparent to those skilled in the art.

What is claimed is:

1. A debugging system for debugging error malfunctions of a target device, comprising:
a debugging device setting a permanent break point in the target device when the debugging device is connected with the target device; and
the target device stopping operation when the connection between the target device and the debugging device is released and the break point is executed,
wherein the debugging device starts debugging the target device from a time point at which the target device operation was stopped.

2. The system of claim 1, wherein setting the break point comprises replacing an arbitrary code of a particular program designated by a user with a break point code.

3. The system of claim 2, wherein when operation of the target device is stopped, and a physical connection is re-eatablished between the debugging device and the target device, the debugging device deletes the break point code and restores an original code in its place.

4. The system of claim 1, wherein the break point is executed when a certain condition is met.

5. The system of claim 1, wherein the target device is a mobile terminal.

6. The system of claim 1, wherein the target device is an embedded system.

7. A debugging device for debugging error malfunctions in a target device, comprising.
a break point setting unit setting a permanent break point in the target device while connected with the target device; and
an error control unit performing debugging on the target device when operation of the target device is stopped by the break point after the connection with the target device is released,
wherein debugging is started from a state at which the target device operation was stopped.

8. The device of claim 7, wherein the break point setting unit replaces an original code with a break point code.

9. The device of claim 8, wherein when the connection with the stopped target device is re-established, the break point setting unit deletes the break point code and restores the original code in its place.

10. The device of claim 7, wherein the target device is a mobile terminal.

11. The device of claim 7, wherein the target device is an embedded system.

12. A target device adapted to be debugged by a debugging device, comprising:
a memory unit storing a program setting and controlling a permanent break point; and
a controller stopping operation of the target device when the break point is executed, and controlling a debugging operation to start debugging from a stopped operation region of the target device,
wherein the permanent break point is sustained even after the target device is disconnected from the debugging device.

13. The device of claim 12, wherein when the operation of the target device is stopped, the controller establishes a connection to the debugging device to allow the debugging device to perform debugging.

14. The device of claim 13, wherein the break point setting unit replaces an original code with a break point code.

15. The device of claim 14, wherein before debugging is performed, the controller deletes the break point code and restores the original code in its place.

16. A method for detecting an error by a debugging system including a debugging device and a target device, the method comprising:
connecting the debugging device to the target device and setting a permanent break point in the target device;
releasing the connection and testing the target device;
stopping an operation of the target device when the break point is executed; and
connecting the debugging device to the target device, and debugging the target device starting from the position at which the operation was stopped.

17. The method of claim 16, further comprising deleting the break point code from the target device and restoring an original code in its place before debugging is performed.

18. The method of claim 16, wherein when setting the permanent break point comprises replacing an arbitrary code of a particular program designated by a user with a break point code.

19. The method of claim 16, wherein the target device is a mobile terminal.

20. The method of claim 16, wherein the target device is an embedded system.
